(19) United States
(12) Patent Application Publication
(10) Pub. No.: US 2019/0377713 A1
(43) Pub. Date: Dec. 12, 2019

(54) MULTI-PLATFORM DATABASE SCHEMA MANAGEMENT

(71) Applicant: Walmart Apollo, LLC, Bentonville, AR (US)

(72) Inventors: Linda Lankford, Bentonville, AR (US); Daniel Bryan Austin, Bentonville, AR (US)

(21) Appl. No.: 16/421,050

(22) Filed: May 23, 2019

Related U.S. Application Data
(60) Provisional application No. 62/676,447, filed on May 25, 2018.

(51) Int. Cl. G06F 16/21; G06F 16/23

(52) U.S. Cl. CPC G06F 16/213; G06F 16/219; G06F 16/2379

(57) ABSTRACT

Database schema management systems and methods. An intake engine can receive a platform-specific schema definition language and an intake template for converting the input schema to a platform-neutral schema. The intake template can define one or more translation operations required to convert from the first platform-specific schema definition language to a platform-neutral schema definition language. In embodiments, the intake engine can validate the input schema based on one or more design criteria. A repository can store platform-neutral schemas and deployment information. An output template can define one or more translation operations to convert from the platform-neutral schema definition language to a platform-specific schema definition language. A deployment engine can deploy a selected schema to a target database upon request.

### RELATED APPLICATION

The present application claims the benefit of U.S. Provisional Application No. 62/676,447 filed May 25, 2018, which is hereby incorporated in its entirety by reference.

### TECHNICAL FIELD

Embodiments of the present disclosure relate generally to the field of database administration, and more particularly to version management systems for database schemas.

### BACKGROUND

In many database applications, it is preferable for multiple separate database instances to share a common data structure, or schema. This allows developers and maintainers of tools that interact with databases to make efficient assumptions about the database structure based on a known baseline.

A common task for database administrators therefore is updating the data structures of multiple database instances to match a “gold” or “master” data schema. This task can be performed manually, via the software interfaces provided by various database systems, or can be automated by the execution of data definition language (DDL) scripts that perform the necessary tasks to modify the schema of a target system. Generally, it is also necessary to create “back out” scripts, which can roll back any of the schema changes in the case of problems.

In many cases, DDL scripts are generated manually, taking into account the current schema in place on each of the target systems. In large environments, this could involve the creation of hundreds of separate scripts. This can be further complicated in heterogeneous data storage systems, where multiple applications and/or users may require different database software, each requiring platform-specific data definition language code. In order to re-use schema definitions across database systems, it is often necessary to translate each schema to multiple target systems. Developers, therefore, may be forced to manually translate between systems, or to manually maintain multiple platform versions of the same schema in order to support all downstream users.

In order to support deployment of database schemas, administrators must also keep track of which schema versions are installed where. For example, when schema changes are proposed, administrators must often manually determine which systems would be affected, and what the extent of those changes will be. Deployment is also a highly technical activity, requiring dedicated database administrators required to ensure that changes are correctly propagated across heterogeneous systems.

### SUMMARY

Embodiments of the present disclosure provide a schema provisioning tool that is extendable to work with any data modeling tool, any intake format, and support any target platform. Embodiments include a robust schema repository that captures and consumes metadata and integrates with metadata services. Embodiments can enable an enhanced workflow for schema approval and provide a secured self-service framework with engagement points. Managed schema sources can enable automation and simplification of database chances, which can reduce the technical skills needed to deploy the schema.

In embodiments, a database schema management system can comprise an intake engine configured to receive an input schema conforming to a platform-specific schema definition language and an intake template, and to convert the input schema to a platform-neutral schema based on the intake template. The input schema can conform to a first platform-specific schema definition language. The intake template can define one or more translation operations required to convert from the first platform-specific schema definition language to a platform-neutral schema definition language. In embodiments, the intake engine can validate the input schema based on one or more design criteria.

A repository can be configured to store a schema record comprising the platform-neutral schema and a deployment record. In embodiments the schema repository is configured to store a plurality of schema records, each schema record further comprising a version identifier.

A deployment engine can be configured to receive a request for the schema record, an identification of a target database system requiring a second platform-specific schema definition language, and an output template. The output template can define one or more translation operations required to convert from the platform-neutral schema definition language to the second platform-specific schema definition language,

The deployment engine can convert the platform-neutral schema to an output schema conforming to the second platform-specific schema definition language based on the output template, and update the deployment record to associate the schema record with the target database system. In embodiments, the deployment engine can be communicably coupleable to the target database system and can install the output schema on the target database system.

In embodiments, the system can comprise a comparator configured to provide an output including one or more differences between a first schema record and a second schema record. In embodiments, the deployment engine can be further configured to evaluate a configuration of the target database system and to provide an output indicating a compatibility level between the configuration and the output schema. In embodiments, the schema record can comprise an approval log and the deployment engine is further configured to refuse the request for the schema record based on the approval log, including whether the schema record is flagged as approved, and by which user(s).

In embodiments, the schema record further can include a user identifier, and the repository can be further configured to provide an output including the user identifier associated with the schema record.

In embodiments, the input schema can comprise a predefined translation section associated with the second data definition language. The intake engine can be configured to store the predefined translation section in the platform-neutral schema without converting the predefined translation section. The deployment engine can be further configured to insert the predefined translation section into the output schema without converting the predefined translation section.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures.

FIG. 1 is a schematic view depicting an architecture of a database schema management system, according to an embodiment.

FIG. 2 is a schematic view depicting data elements in a repository, according to an embodiment.

FIG. 3 is a schematic view depicting data elements in a schema record, according to an embodiment.

FIG. 4 is a schematic view depicting a data structure for a repository, according to an embodiment.

FIG. 5 is a schematic view depicting actions in a user interface, according to an embodiment.

FIG. 6 is a flowchart depicting a method for receiving a schema, according to an embodiment.

FIG. 7 is a flowchart depicting a method for deploying a schema to a target database, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

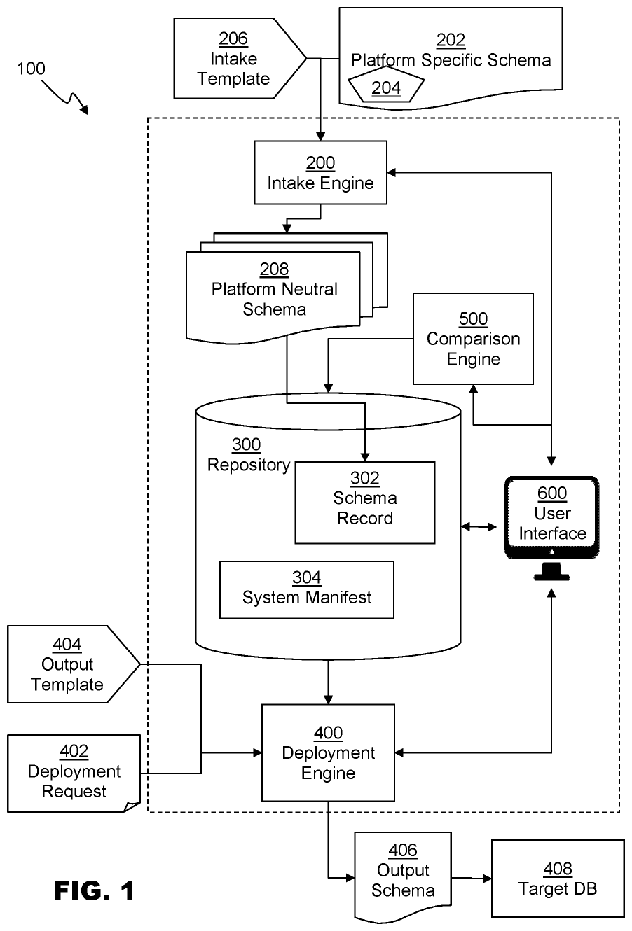

FIG. 1 is a schematic view depicting an architecture of a database schema management system 100, according to an embodiment. System 100 can comprise intake engine 200, repository 300, deployment engine 400, comparison engine 500, and user interface 600.

As used through this disclosure, a database is a structured set of data held in a computer. Database software provides functionalities that allow building, modifying, accessing, and updating both databases and the underlying data. Databases and database software reside on database servers. Database servers are collections of hardware and software that provide storage and access to the database and enable execution of the database software.

Intake engine 200 can receive platform-specific schema 202 and intake template 206 as input. Platform-specific schema 202 may be created via one or more modeling tools known in the art such as erWIN Data Modeler, ER/Studio, PowerDesigner, or the like. Platform-specific schema 202 can be a data definition language file defining one or more objects 204 that make up the data structure for a database. Typical object types include: Databases, Tables, Views, Synonyms, Sequences, Foreign Keys, and Procedures. In addition, objects such as tables may include a number of sub-objects such as Columns, Indexes, Binary Indexes, Primary Keys, Unique Keys, and Triggers. Platform-specific schema 202 can describe all or part of one or more relational databases with tabular structure, or NoSQL or other non-relational databases with key-value, grid, or other structures.

The definition of each object 204 includes the information required to replicate that object in the schema of another database. In embodiments, platform-specific schema 202 can include the following data items: name, type, size, locale indicators (for example Unicode, or non-Unicode for Database objects), and definitions of sub-objects. In embodiments, the definition of an object 204 may include data items related to the physical storage of the object 204, for example storage space names, and fragmentation information regarding how objects are split across storage spaces. Where storage information is included, platform-specific schema 202 can include the information required to ensure that a target database has adequate storage for the objects. In embodiments, platform-specific schema 202 may be stored as one or more XML files, text files, or any other suitable data storage format.

Those of ordinary skill in the art will appreciate that database systems and related tools (such as modeling tools) can receive and/or output schemas in a number of different data definition languages. Intake template 206 can be provided to intake engine 200 to enable intake engine 200 to convert platform-specific schema 202 to a platform-neutral schema 208. In embodiments, intake template 206 can comprise a configuration file (such as a text or XML file) including data entries defining how to translate from the syntax of the platform-specific schema language to the syntax of the platform-neutral schema language. In another embodiment, intake template 206 can comprise a plug-in, script, application, module, class, or other form of executable instructions configured to receive platform-specific schema 202 as input and produce platform-neutral schema 208 as output.

In embodiments, platform-neutral schema 208 can comprise one or more files containing an instance of a specialized data definition language. The files can comprise text, HTML, XML, binary files, database archives, or any other file format. Such a language can include support for a number of entity types, each having one or more attributes including, but not limited to, those listed in Table 1 below.

TABLE 1

| Entity Name | Attributes |
|---|---|
| Database | Description |
| | Database Name |
| Table | Description |
| | TableName |
| | DatabaseName |
| Column | ColumnDesc |
| | ColumnName |
| | ColumnNumber |
| | TableName |
| | Datatype |
| | Default |
| | NullOption |
| Index | IndexName |
| | IndexType |
| | TableName |
| | ColumnNames[ ] |
| PrimaryKey | PrimaryKeyName |
| | TableName |
| | ColumnNames[ ] |
| ForeignKey | ForeignKeyName |
| | TableName |
| | ColumnNames[ ] |
| | ParentTable |
| | ParentColumnNames[ ] |

The data types supported for each column entity can include: Small Integer (SMALLINT), Integer, Big Integer (BIGINT), Serial, Big Serial, Globally Unique Identifier (GUID), Decimal, Character (CHAR), Variable Character (VARCHAR), Unicode Character NCHAR, Unicode Variable Character, NVARCHAR, Blob, Clob, Boolean, Time, Date, Datetime, Interval.

In embodiments, platform-specific schema 202 and platform-neutral schema 208 can comprise one or more pretranslated sections 216. Each pretranslated section 216 can comprise a platform-specific output data definition 218 that conforms to one or more platform-specific output data definition languages. Intake engine 200 can store provided pretranslated sections 216 in platform-neutral schema 208 without further processing. Pretranslated sections 216 can enable users to take advantage of platform-specific features in ways that are not supported by intake engine 200 and deployment engine 400. For example, stored procedure code can be difficult to automatically translate efficiently, so users may choose to provide multiple versions of the same stored procedure(s) that have been manually (or automatically) ported for compatibility with a plurality of different database systems.

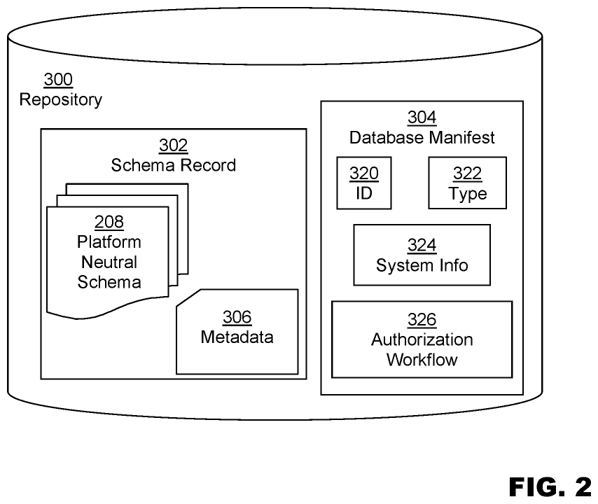

FIG. 2 is a schematic diagram depicting data elements that can be stored in repository 300, according to an embodiment. Repository 300 can comprise a database or other data store. Repository 300 can store schema records 302 and database manifest 304.

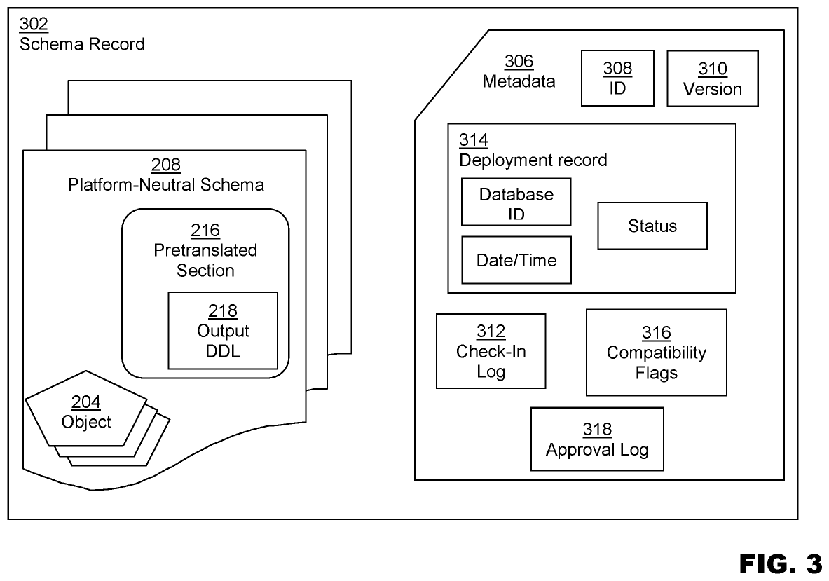

FIG. 3 is a schematic view depicting data elements of a schema record 302, according to an embodiment. Schema record 302 can comprise the content of, or link to the location of, a platform-neutral schema 208 as processed by intake engine 200. Schema record 302 can further comprise metadata 306 for each platform-neutral schema 208. Metadata 306 can comprise a variety of attributes regarding each platform-neutral schema 208, including but not limited to: an identifier 308 (which can include a name and/or GUID), a version 310, a check-in log 312 (including date/time stamp(s) and user identification), one or more deployment records 314, compatibility flags 316, and approval log 318. In embodiments, multiple schema records 302 can be associated with the same schema, such that each schema record 302 is a different version of the parent schema.

Each deployment record 314 can indicate which, if any, database systems (such as target database 408, discussed below) the platform-neutral schema 208 associated with schema record 302 has been deployed to. Deployment record 314 can record an identifier for the database system, a time/date stamp of the deployment, and a status of the deployment. Deployment status can include Pending Deployment, Unsuccessful Deployment, Successful Deployment and Cancelled. While depicted as a component of metadata 306, deployment record 314 can, in embodiments, be associated with the database manifest 304 of each database system, and include links or other references to the associated schema records 302.

Compatibility flags 316 can comprise lists or other groupings of platforms that the platform-neutral schema 208 is, or is not compatible with. While ideally, the provided platform-specific schema 202 will be compatible (via translation) with all possible target databases 408, it is often desirable to take advantage of features available in only a subset of target database systems. These features may be unavailable in certain systems because the target database system does not support them, or because the intake templates 206 or output templates 404 (described below) do not support the translation. Compatibility flags 316 can be set automatically by intake engine 200 (based on, for example, the features present in platform-specific schema 202) and/or can be provided by the user when the schema is checked in.

Schema record 302 can further comprise approval log 318. Approval log 318 can track the date, time, and user identifier of user approvals of checked in schemas. For example a user can indicate that a particular schema needs to be approved by a member of a quality assurance team before a new version can be deployed to production database systems.

Returning to FIG. 2, repository 300 can comprise a database manifest 304 for each database registered with system 100. Manifest 304 can comprise a system identifier 320 which can be a name, GUID, uniform resource locator (URI) and/or other data that can be used to identify the database resource. Type 322 can indicate whether the database is a development, test, production, or other database. System information 324 can provide the version, data definition language, and other configuration information of the database system.

Authorization workflow 326 can be used to define which user approvals are required before a schema can be deployed to the database. In embodiments, authorization workflow 326 can include a list of users or user rules. In other embodiments, authorization workflow can include multiple authentication layers or steps, and can vary based on database type 322. For example, a production database may require all schemas to be approved by a member of an operations team, or two members of an emergency response team before deployment.

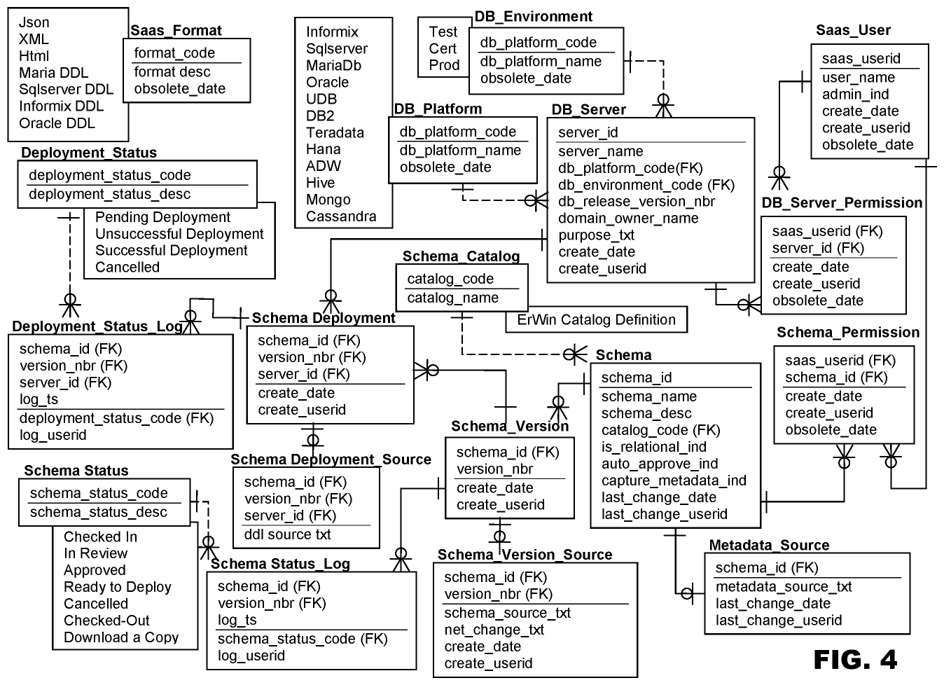

FIG. 4 is a schematic view depicting a data model for an embodiment of repository 300, including tables, columns, and relationships, according to an embodiment. Those of ordinary skill will appreciate that the data model provided in FIG. 4 is just one of many possible implementations of repository 300.

Returning now to FIG. 1, deployment engine 400 can receive deployment request 402 and output template 404 as input. Deployment request 402 can comprise identifiers for a schema record 302 and a target database 408, requiring one or more platform-specific data definition languages. Deployment engine 400 can use output template 404 to produce output schema 406 in a platform-specific data definition language that is compatible with target database 408.

Output template 404 can be provided to deployment engine 400 to enable deployment engine 400 to convert platform-neutral schema 208 to a platform-specific output schema 406. Output template 404 can comprise the same or similar files, formats, and types as described with respect to intake template 206 above. In embodiments, output template 404 and intake template 206 can be combined in a single input file, plug-in, or application, providing support for converting between one or more platform-special data definition languages. In one embodiment, intake template 206 and output template 404 can be included in a single plug-in or application programming interface providing a translate function to read a platform-specific schema and produce a platform-neutral schema, and an interpret function to read a platform-neutral schema, and produce a platform-specific schema.

Processing of platform-neutral schema 208 can comprise converting each object 204 from the platform-neutral language to a language that is compatible with target database 408. Pretranslated sections 216 can be processed by identifying a pretranslated section that specifies the target database language and inserting the pretranslated object definitions without additional translation.

Deployment engine can be configured to install output schema 406 on the target database system 408 and update deployment record 314 accordingly. Deployment engine can perform one or more readiness checks before initiating the install of output schema 406 to target database 408.

Comparison engine 500 can receive at least two schemas (either platform-neutral or platform-specific), and produce an output related to any differences between them. The output can be provided via user interface 600, or programmatically to one or more components of system 100 or external application components. In one embodiment, comparison engine can use intake engine 200 to produce a platform-neutral version of each platform-specific input schema for comparison. In other embodiments, comparison engine can use deployment engine 400 to produce one or more platform-specific versions of platform-neutral input schemas for comparison.

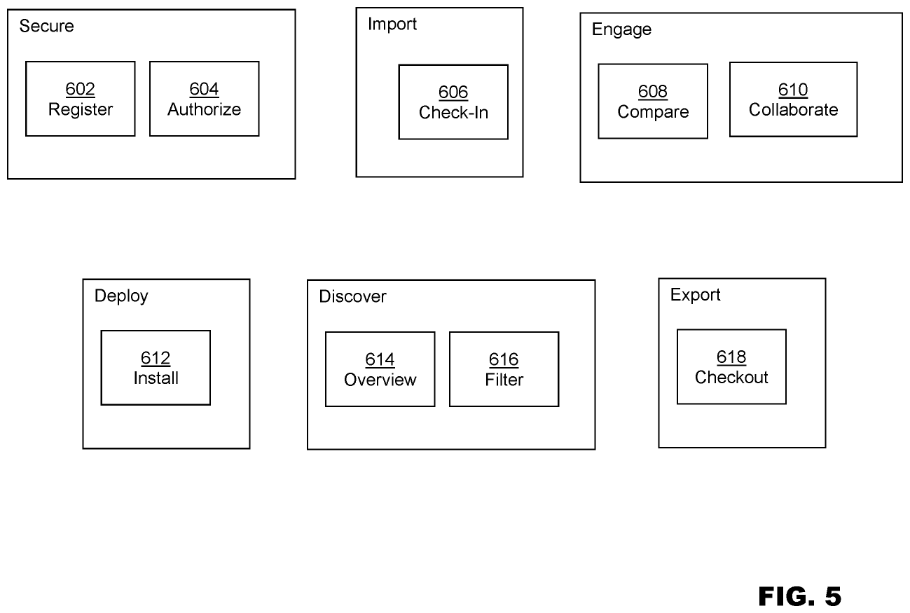

FIG. 5 is a schematic view depicting categories of actions and functions that can be enabled by user interface 600, in operation with the other components of system 100, according to one embodiment. User interface 600 can comprise a human-computer interface and receive user inputs and provide user outputs for interacting with system 100. User interface 600 can comprise a mobile application, web-based application, or any other executable application framework. User interface 600 can reside on, be presented on, or be accessed by any computing devices capable of communicating with the various components of system 100, receiving user input, and presenting output to the user. In embodiments, user interface 600 can reside or be presented on a smartphone, a tablet computer, laptop computer, or desktop computer.

User interface 600 can further comprise one or more application programming interfaces (APIs), services, or other programmatic interface enabling human or program users to interface with system 100. In embodiments, user interface 600 can comprise one or more RESTful (Representational State Transfer) web services, SOAP web services, and the like.

The secure category can include registration actions 602 and authorization actions 604. Registration actions 602 can include registering target databases 408 and schemas under management. Registration actions can enable the user to view, provide, and/or modify server names, platforms, database types, database system versions, schema names, domain owners, and database/schema purposes. Authorization actions can include viewing, providing, and/or modifying users, roles and rights, server permissions, and schema permissions (including, for example, authorization workflows 326.

The import category can include check-in actions 606. Check-in actions 606 can enable a user to provide a platform-specific schema 202 for intake and storage within repository 300. Check-in actions can enable the user to view, provide, and/or modify the intake format (platform-specific DDL), the schema name, and the schema source. Check-in actions 606 can also automatically capture (or enable the user to provide) metadata, including content descriptions and sizing information.

The engage category can include compare actions 608 and collaborate actions 610. The compare actions can provide an interface to comparison engine 500 enabling the user to determine differences between schemas, and between versions of the same schema. The collaborate actions 610 can enable to view checked-in schemas, provide approvals, and determine/indicate whether a schema record 302 is ready to deploy.

The deploy category can include install actions 612. Install actions 612 can include dynamic DDL generation (using output template 404) from platform-neutral schema 208. Install actions 612 can also allow the user to view, provide and/or modify the deployment request 402 including the schema version, schema name, target platform environment, scheduled deployment date/time and deployment status.

The discover category can include overview actions 614 and filter actions 616. The overview actions 614 can enable the user to generate reports based on the current status of the schemas and database systems under management by system 100. The filter actions 616 can enable the user to drill down to various views that may be helpful to the user. Filter actions 616 can be implemented by querying repository 300, for example by providing previously developed queries in a language such as Structured Query Language (SQL), or enabling the user to provide custom queries. Example filters that can be supported by embodiments include (but are not limited to): What's New (servers, schemas, users, permissions), What's This (content descriptions, domain owners, sizing), What's the Status (ready for review, ready for deployment), and What's Done (changes to Test, changes to Production).

The export category can include checkout actions 618. Checkout actions 618 can enable the user to specify versions and/or formats based on a given schema record 302. For example, checkout actions 618 can enable the user to receive the platform-neutral schema 208, or a version that has been converted to a platform-specific language based on output template 404. Checkout actions 618 can further enable the user to download a copy (in the chosen format(s)), or to export the schema to an external tool, such as Enhance.

The various components of system 100 can comprise a schema provisioning tool that is extendable to work with any data modeling tool, any intake format, and support any target platform. System 100 includes a robust schema repository to capture and consume metadata and integrate with metadata services. System 100 can enhance current database develop workflows and provide a secured self-service framework including multiple engagement points.

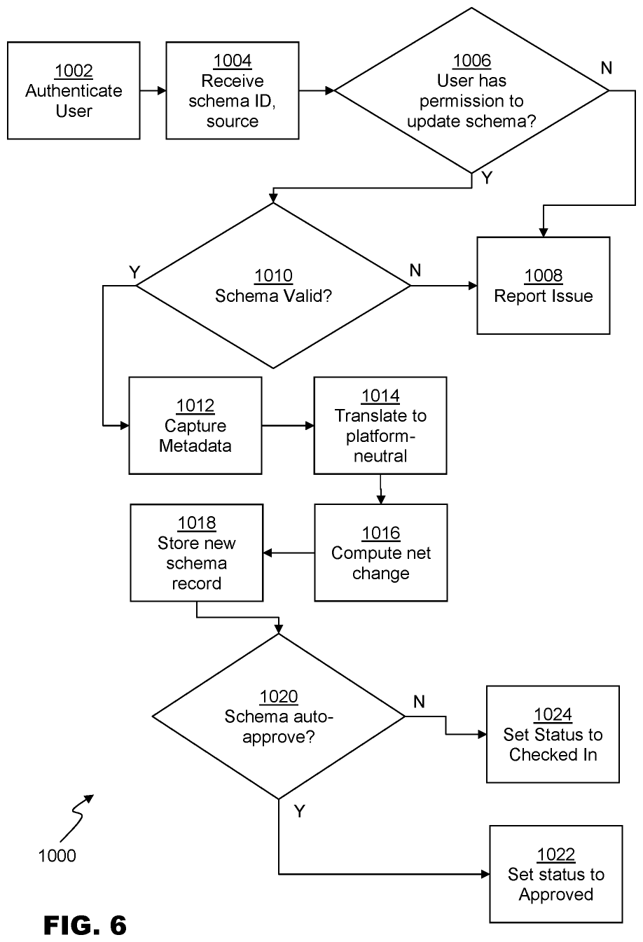

Embodiments of the present disclosure also include methods for managing schema source code to automate and simplify database changes, reducing the technical skills needed to deploy new schemas. As one example, FIG. 6 is a flowchart depicting a method 1000 for creating and/or updating a schema record 302 based on a provided platform-specific schema 202.

At 1002, the user can be authenticated, for example by providing a log-in and password, or other credentials. At 1004, user can provide an identifier of the schema, or schema record, and the source of the platform-specific schema 202 to be checked in. At 1006, intake engine 200 can verify that the user has permission to update to chosen schema. If not, an issue can be reported at 1008. If the user has permission, the provided platform-specific schema 202 can be parsed and checked for validity at 1010. The validity check can also ensure that platform-specific schema 202 is consistent with one or more previously defined design criteria. Examples of design criteria can include object naming schemes, relationship attributes, index parameters, and the like. Any errors can be reported at 1008. If the schema is valid, intake processing can proceed to 1012.

At 1012, metadata can be captured. This metadata can be schema metadata 306, and/or metadata related to the objects defined in platform-specific schema 202. If new objects are defined, the user can be asked to provide or edit object metadata. At 1014, the intake template 206 can be used to transform platform-specific schema 202 to platform-neutral schema 208. Processing platform-specific schema 202 to produce platform-neutral schema 208 can comprise iterating through each object in platform-specific schema 202 and converting it to the platform-neutral data definition language. Pretranslated sections in platform-specific schema 202 can be stored in platform-neutral schema 208 with the identifiers of the associated output data definition languages.

At 1016, the net change between a previous schema version and the new schema can be computed, for example by comparison engine 500. The net change can be stored in repository 300 and/or presented to the user. At 1018, a new schema record 302 can be created, storing the platform-neutral schema 208, and associated metadata 306. At 1020, if the schema is set to be auto-approved, the schema record 302 can be given an Approved status at 1022. Otherwise, the schema can be given a “Checked In” status at 1024. Schema records 302 with a “Checked In” status can be approved by other users at a later time.

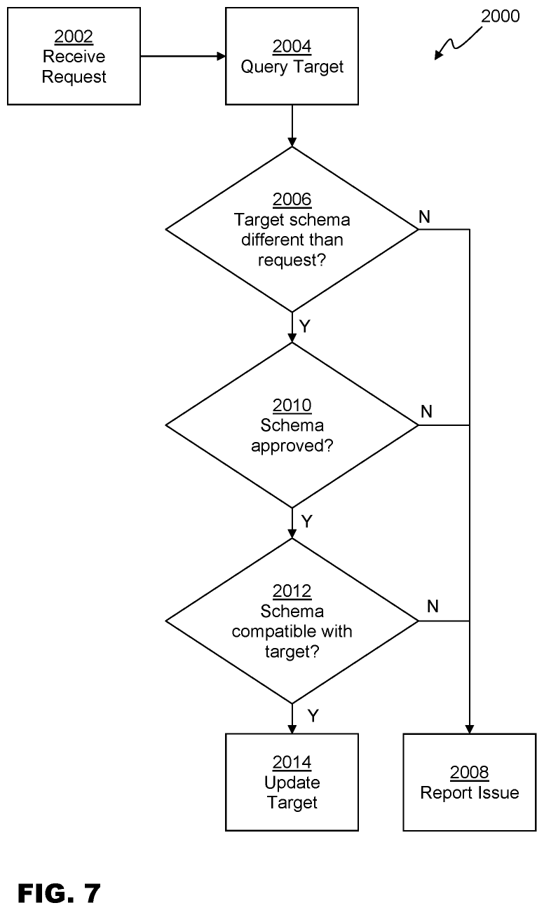

FIG. 7 is a flowchart depicting a method 2000 for determining readiness prior to deploying output schema 406.

At 2002, a deployment request can be received. At 2004, the target database can be queried to determine the current status and attributes. At 2006, the schema currently installed on the target database can be checked to ensure that it is different than the requested schema. In embodiments, the check can be performed by reviewing the appropriate deployment records 314, database manifests 304 in repository 300. The check can also be performed by identifying a version number from target database 408 and/or by performing an analysis to compare the schema currently installed on target database 408. For example, intake engine 200 can be used to produce a platform-neutral image of the schema on target database 408 for comparison purposes. If the target schema is not different from the schema on the database, an issue or error message can be reported at 2008.

At 2010, the requested schema record 302 can be evaluated to ensure that the necessary approvals have been received. If not, an issue or error message can be reported at 2008. If the schema is approved, processing can be continued at 2012.

At 2012, the requested schema record 302 can be evaluated to determine if the schema 302 is compatible with the target database, for example, by comparing compatibility flags 316 with the system of target database 408. If not, an issue or error message can be reported at 2008. If the schema is approved, the target database can be updated at 2014.

The systems and methods of the present disclosure include numerous advantages over prior systems and techniques. System 100 can be format agnostic, accepting multiple intake formats (such as DDL, HTML, JSON, and the like). The system can be extendable to other formats, and translates and converts to standard data types and a common format. Embodiments are tool agnostic, and can support the use of multiple modeling tools. Embodiments are also platform agnostic, and can be extendable to accept multiple target platforms.

The centralized schema repository can provide engagement points for review and status management. Secured check-in, check-out, and deployment can ensure that appropriate approvals are in place before changes are made, and deployments and other changes can also be logged to provide tracking and audit capabilities. The repository can contain full versions of schema source code and database objects. The comparison engine can produce net change documentation. Embodiments can capture changes, environments, and installations, and can capture metadata such as row counts and content descriptions.

Embodiments of the present disclosure provide systems and methods to assist with the rapid design and deployment of database schemas across large data storage systems with diverse configurations and needs. Embodiments further enable automation of the schema deployment process.

It should be understood that the individual steps used in the methods of the present teachings may be performed in any order and/or simultaneously, as long as the teaching remains operable. Furthermore, it should be understood that the apparatus and methods of the present teachings can include any number, or all, of the described embodiments, as long as the teaching remains operable.

In one embodiment, the system 100 and/or its components or subsystems can include computing devices, microprocessors, modules and other computer or computing devices, which can be any programmable device that accepts digital data as input, is configured to process the input according to instructions or algorithms, and provides results as outputs. In one embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In one embodiment, volatile memory can include random access memory (RAM), dynamic random access memory (DRAM), or static random access memory (SRAM), for example. In one embodiment, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the disclosure.

In one embodiment, the system or components thereof can comprise or include various modules or engines, each of which is constructed, programmed, configured, or otherwise adapted to autonomously carry out a function or set of functions. The term “engine” as used herein is defined as a real-world device, component, or arrangement of components implemented using hardware, such as by an application-specific integrated circuit (ASIC) or field-10 programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that embodiments may comprise fewer features than illustrated in any individual embodiment described above. The embodiments described herein are not meant to be an exhaustive presentation of the ways in which the various features may be combined. Accordingly, the embodiments are not mutually exclusive combinations of features; rather, embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is intended also to include features of a claim in any other independent claim even if this claim is not directly made dependent to the independent claim.

Moreover, reference in the specification to “one embodiment,” “an embodiment,” or “some embodiments” means that a particular feature, structure, or characteristic, described in connection with the embodiment, is included in at least one embodiment of the teaching. The appearances of the phrase “in one embodiment” in various places in the specification are not necessarily all referring to the same embodiment.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of Section 112, sixth paragraph of 35 U.S.C. are not to be invoked unless the specific terms “means for” or “step for” are recited in a claim.

What is claimed is:

1. A database schema management system comprising:
an intake engine configured to:
receive an input schema conforming to a first platform-specific schema definition language and an intake template defining one or more translation operations required to convert from the first platform-specific schema definition language to a platform-neutral schema definition language, and
convert the input schema to a platform-neutral schema based on the intake template;
a repository configured to store a schema record comprising the platform-neutral schema and a deployment record; and
a deployment engine configured to:
receive a request for the schema record, an identification of a target database system requiring a second platform-specific schema definition language, and an output template defining one or more translation operations required to convert from the platform-neutral schema definition language to the second platform-specific schema definition language,
convert the platform-neutral schema to an output schema conforming to the second platform-specific schema definition language based on the output template, and
update the deployment record to associate the schema record with the target database system.

2. The system of claim 1, wherein the deployment engine is communicably coupleable to the target database system and is further configured to install the output schema on the target database system.

3. The system of claim 1, wherein the repository is configured to store a plurality of schema records, each schema record further comprising a version identifier.

4. The system of claim 3, further comprising a comparator configured to provide an output comprising one or more differences between a first schema record and a second schema record.

5. The system of claim 1, wherein the intake engine is further configured to validate the input schema based on one or more design criteria.

6. The system of claim 1, wherein the deployment engine is further configured to evaluate a configuration of the target database system and to provide an output indicating a compatibility level between the configuration and the output schema.

7. The system of claim 1, wherein the schema record further comprises an approval log and wherein the deployment engine is further configured to refuse the request for the schema record based on the approval log.

8. The system of claim 1, wherein the schema record further comprises a user identifier, and wherein the repository is further configured to provide an output including the user identifier associated with the schema record.

9. The system of claim 1, wherein the input schema comprises a predefined translation section associated with the second platform-specific schema definition language;
wherein the intake engine is further configured to store the predefined translation section in the platform-neutral schema without converting the predefined translation section; and
wherein the deployment engine is further configured to insert the predefined translation section into the output schema without converting the predefined translation section.

10. A method for managing database schemas in a computing system comprising a repository, the method comprising:
receiving an input schema conforming to a first platform-specific schema definition language and a intake template defining one or more translation operations required to convert from the first platform-specific schema definition language to a platform-neutral schema definition language;
converting the input schema to a platform-neutral schema based on the intake template;
storing a schema record comprising the platform-neutral schema and a deployment record in the repository;
receiving a request for the schema record, an identification of a target database system requiring a second platform-specific schema definition language, and an output template defining one or more translation operations required to convert from the platform-neutral schema definition language to the second platform-specific schema definition language;
converting the platform-neutral schema to an output schema conforming to the second platform-specific schema definition language based on the output template; and
updating the deployment record to associate the schema record with the target database system.

11. The method of claim 10, further comprising installing the output schema on the target database system.

12. The method of claim 10, wherein the schema record further comprises a version identifier.

13. The method of claim 10, further comprising providing an output comprising the differences between a first schema record and a second schema record.

14. The method of claim 10, further comprising validating the input schema based on one or more design criteria.

15. The method of claim 10, further comprising evaluating a configuration of the target database system and providing an output indicating a compatibility level between the configuration and the output schema.

16. The method of claim 10, further comprising storing an approval log in the schema record and refusing the request for the schema record based on the approval log.

17. The method of claim 10, further comprising storing a user identifier in the schema record.

18. The method of claim 10, wherein converting the input schema to the platform-neutral schema further comprises detecting a predefined translation section associated with the second platform-specific schema definition language in the input schema and storing the predefined translation section in the platform-neutral schema without conversion; and wherein
converting the platform-neutral schema to the output schema further comprises inserting the predefined translation section into the output schema without conversion.
